(19) United States
(12) Patent Application Publication
(10) Pub. No.: US 2005/0267229 A1
(43) Pub. Date: Dec. 1, 2005

(54) Method for producing poly(methyl methacrylate)-metal cluster composite

(75) Inventor: Shin Horiuchi, Tokyo (JP)

Correspondence Address: MORGAN LEWIS & BOCKIUS LLP, 1111 PENNSYLVANIA AVENUE NW, WASHINGTON, DC, 20004, US

(73) Assignee: National Institute of Advanced Industrial Science and Technology, Tokyo (JP)

(21) Appl. No.: 10/527,052

(22) PCT Filed: Sep. 3, 2003
(86) PCT No.: PCT/JP03/11249

§ 371 Date: Mar. 9, 2005

(30) Foreign Application Priority Data
Sep. 10, 2002 (JP) 2002-264630

(51) Int. Cl. C08K 3/00

(52) U.S. Cl. 522/71

(57) ABSTRACT

A process for efficiently producing a poly(methyl methacrylate)-metal cluster composite, a patterning material obtainable by the process, and its patterning method are provided. The poly(methyl methacrylate)-metal cluster composite is obtained by bringing a poly(methyl methacrylate) base plate having an ultraviolet-irradiated portion into contact with vapor of a heavy metal compound to form heavy metal nanoparticles on the ultraviolet-irradiated portion.

### TECHNICAL FIELD

The present invention relates to a novel process for producing a poly(methyl methacrylate)-metal cluster composite which is expected to be useful as optical materials, electronic materials, and the like. More specifically, the present invention relates to a process for efficiently producing a poly(methyl methacrylate)-metal cluster composite using poly(methyl methacrylate) and a heavy metal complex as raw materials, and a patterning material obtained by the process.

### BACKGROUND ART

A composite in which a polymer compound is used as a matrix and a heavy metal is dispersed therein in a fine state, i.e., so-called a polymer-metal cluster composite, has a non-linear optical property and a high elastic modulus property or is colored stably, so that the complex has attracted attention as non-linear optical materials, high elastic modulus materials, decorative materials, and the like. However, since it involves many difficulties to uniformly disperse fine heavy metal particles in a matrix material, various devices are necessary for overcoming the problems. Thus, some proposals have hitherto been performed, but there are problems that all these methods contain diversified steps and operations thereof are complicated.

For solving these problems, the present inventors have previously proposed “a process for producing a poly(methyl methacrylate)-metal cluster composite, wherein the metal cluster is homogeneously and uniformly dispersed over the whole polymer by bringing vapor of a heavy metal compound into contact with a solid polymer compound at a temperature of its glass transition temperature or higher” (Japanese Patent No. 3062748) and “a process for producing a polymer-metal cluster complex using as the above polymer a block copolymer obtainable by combining two or more kinds of polymer chains at respective terminals, the polymer chains being non-compatible with each other and having different reducing power toward a heavy metal compound (Japanese Patent No. 3309139).

On the other hand, poly(methyl methacrylate) is extremely useful as basal plate films such as self-disintegrative photoresist materials, optical fibers, and the like. In particular, when the heavy metal cluster complex is efficiently formed, a wide variety of applications thereof are expected as materials for expressing functions and properties for nanolithography, photonic crystals, high-density recording media, catalysts, or the like.

However, poly(methyl methacrylate) has, unlike other polymer compounds, weak reducing power toward heavy metal compounds and hence it is very difficult to obtain metal cluster complexes thereof (cf. ADVANCE MATERIALS, 2000, 12, No. 20, 1506-1511).

The present invention has been accomplished in consideration of the above circumstances in the conventional art. Thus, an object of the present invention is to provide an efficient process for producing a poly(methyl methacrylate)-metal cluster composite and a patterning material comprising the poly(methyl methacrylate)-metal cluster composite obtainable by the method as well as a method for patterning the same.

### DISCLOSURE OF THE INVENTION

As a result of extensive studies on a process for producing a poly(methyl methacrylate)-metal cluster composite, the present inventors have found that poly(methyl methacrylate) changes in structure upon ultraviolet irradiation to remarkably increase the reducing power toward heavy metal compounds and when a heavy metal compound is brought into contact with the ultraviolet-irradiated portion, a metal cluster is formed inside the poly(methyl methacrylate). Based on the findings, they have accomplished the present invention.

Namely, the present invention provides the following inventions.
(1) A process for producing a poly(methyl methacrylate)-metal cluster composite, which comprises bringing poly(methyl methacrylate) into contact with a heavy metal compound under ultraviolet irradiation.
(2) A process for producing a poly(methyl methacrylate)-metal cluster composite, which comprises bringing a poly(methyl methacrylate) basal plate having an ultraviolet-irradiated portion into contact with vapor of a heavy metal compound to form heavy metal nanoparticles on the ultraviolet-irradiated portion.
(3) The process for producing a poly(methyl methacrylate)-metal cluster composite according to the above (1) or (2), wherein the heavy metal compound is selected from acetylacetonate complexes of palladium, cobalt or copper.
(4) The process for producing a poly(methyl methacrylate)-metal cluster composite according to the above (2), wherein the poly(methyl methacrylate) basal plate is brought into contact with vapor of the heavy metal compound in a non-oxidizing atmosphere.
(5) The process for producing a poly(methyl methacrylate)-metal cluster composite according to the above (2), wherein the poly(methyl methacrylate) basal plate is brought into contact with vapor of the heavy metal compound at a temperature of glass transition temperature of the poly(methyl methacrylate) basal plate or higher.
(6) The process for producing a poly(methyl methacrylate)-metal cluster composite according to any one of the above (2) to (5), wherein the ultraviolet-irradiated portion is formed in a predetermined pattern.
(7) The process for producing a poly(methyl methacrylate)-metal cluster composite according to the above (6), wherein the predetermined pattern is formed by masking.
(8) A patterning material which comprises a poly(methyl methacrylate)-metal cluster composite obtainable by the process according to any one of the above (1) to (7).
(9) A method for patterning metal nanoparticles having a predetermined form on a poly(methyl methacrylate) basal plate, which comprises forming a masking portion having a predetermined form on the poly(methyl methacrylate) basal plate having an ultraviolet-irradiated portion, and then bringing the plate into contact with vapor of a heavy metal compound to form metal nanoparticles on a non-masking portion.

### BRIEF DESCRIPTION OF THE DRAWINGS

FIG. 1 is a photograph on a scanning electron microscope of a micropatterning formed on a light-irradiated film of the patterning material obtained in Example 1.

FIG. 2 is a photograph on a transmission electron microscope of cross-section of the patterning material obtained in Example 1.

FIG. 3 is a photograph on a transmission electron microscope of a micropatterning formed on a light-irradiated film of the patterning material obtained in Example 3.

### BEST MODE FOR CARRYING OUT THE INVENTION

The process of the present invention is accomplished based on the novel findings that poly(methyl methacrylate) changes in structure upon ultraviolet irradiation to remarkably increase the reducing power toward heavy metal compounds and when the ultraviolet-irradiated portion is brought into contact with a heavy metal compound, a metal cluster is formed inside the poly(methyl methacrylate).

Therefore, poly(methyl methacrylate) for use in the present invention should be subjected to at least ultraviolet irradiation in the process of bringing it into contact with a heavy metal compound. The ultraviolet irradiation may be carried out during the process of bringing it into contact with the heavy metal compound or the ultraviolet irradiation may be carried out prior to the contact with the heavy metal compound in advance.

The dose and period of ultraviolet irradiation are not particularly limited and depend on the film thickness, but the dose is usually from 0.1 to 2 J/cm².

As poly(methyl methacrylate), any known one may be used, but one having a molecular weight of 10,000 to 1,000,000 is preferably used.

Moreover, in the present invention, vapor of the heavy metal compound comes into contact with poly(methyl methacrylate) having an ultraviolet-irradiated portion in a glass state to dissolve into the poly(methyl methacrylate) and the heavy metal compound dissolved in the ultraviolet-irradiated portion is more rapidly reduced to form a metal cluster. Therefore, as poly(methyl methacrylate), it is particularly preferred to use one which is in a glass state at a treating temperature, preferably one which has a glass transition temperature of from 50 to 200° C.

The shape of poly(methyl methacrylate) is not particularly limited and may be any of shapes, such as particles, granules, pellets, basal plates (films, sheets), molded articles, and fibers. However, in consideration of an application as a patterning material to be mentioned below, it is preferred to select a shape utilizable as a basal plate, e.g., a film or a sheet.

Furthermore, as the heavy metal compound, a sublimating or volatile compound or complex compound that vaporizes under treating conditions is used. Examples of the compounds include compounds of heavy metals of iron, ruthenium, osmium, cobalt, rhodium, nickel, palladium, platinum, copper, silver, gold and the like, such as tetracarbonyl(η-methyl acrylate)iron(0) (sublimation: 10⁻² mmHg), tricarbonyl(η-1,3-cyclohexadiene)iron(0) (bp: 50-66° C./1 mmHg), tricarbonyl(cyclobutadiene)iron(0) (47/3 mmHg), (η-cyclopentadienyl)(η-formylcyclopentadienyl)iron(II) (sublimation: 70° C./1 mmHg), (η-allyl)tricarbonylcobalt (bp: 39° C./15 mmHg), nonacarbonyl(methylidine)tricobalt (sublimation: 50° C./0.1 mmHg), dicarbonyl(pentamethylcyclopentadienyl)rhodium(I) (sublimation: 80-85° C./10-20 mmHg), pentahydridobis(trimethylphosphine)iridium(V) (sublimation: 50° C./1 mmHg), (η3-allyl)(η-cyclopentadienyl)nickel(II) (bp: 50° C./0.45 mmHg), tris(η-cyclopentadienyl)[μ3-(2,2-dimethylpropylidine)]trinickel (sublimation: 115-120° C./1 mmHg), η-cyclopentadienyl(η-allyl)platinum (sublimation: 25° C./0.01 mmHg), chloro(trans-cyclooctene)gold(I) (bp: 115° C.), and chloro(cyclohexene)gold(I) (bp: 60° C.). Particularly preferred are acetylacetonate complexes, such as bis(acetylacetonato)palladium(II) (sublimation: 160° C./0.1 mmHg), bis(acetylacetonato)cobalt(II) (sublimation: 170° C.), and bis(acetylacetonato)copper(II) (sublimation: 65-110° C./0.02 mmHg).

In the process of the present invention, it is preferred to bring poly(methyl methacrylate) and the heavy metal compound into contact with each other in the ratio so as to obtain a complex containing 0.01 to 40 parts by weight, preferably 0.1 to 2 parts by weight, of the heavy metal compound in terms of the heavy metal per 100 parts by weight of poly(methyl methacrylate). As the atmosphere at this time, it is advantageous to use a non-oxidizing atmosphere, i.e., an atmosphere of an inert gas such as nitrogen or argon having an oxygen partial pressure of 1 mmHg or less. The atmosphere may be any of reduced pressure, normal pressure, and enhanced pressure.

As the treating temperature in the process of the present invention, it is necessary to select a temperature of glass transition temperature of the poly(methyl methacrylate) used as the raw material or higher. When the treating temperature is lower than the above temperature, vapor of the heavy metal compound cannot be dissolved because the poly(methyl methacrylate) does not become in a glass state.

The period of contact with vapor of the heavy metal compound in the process of the present invention depends on the treating temperature, but is usually selected from the range of 10 minutes to 5 hours. When a compound of platinum or copper is used after the contact treatment, it is preferred to conduct post-heating for 10 minutes to 50 hours in order to complete cluster formation. The longer the period is, the more the content of the metal cluster in the complex obtained increases.

The process for producing a poly(methyl methacrylate)-metal cluster composite useful as a patterning material is described below.

The metal cluster complex is obtained by bringing a poly(methyl methacrylate) basal plate having an ultraviolet-irradiated portion into contact with vapor of the heavy metal compound to form heavy metal particles on the ultraviolet-irradiated portion.

The method for obtaining the poly(methyl methacrylate) basal plate having an ultraviolet-irradiated portion is not particularly limited and may be selected from methods such as (1) a method of forming a masking portion on the poly(methyl methacrylate) basal plate beforehand and then irradiating a non-masking portion with ultraviolet ray, (2) a method of irradiating all over the poly(methyl methacrylate) basal plate with ultraviolet ray beforehand and then forming a masking portion having a predetermined shape, and (3) a method of scanning a light from an optical fiber or a laser beam on the poly(methyl methacrylate) basal plate. Among these, the method (1) is preferred from the viewpoints that patterning is efficiently carried out at a large area and a masking material can be re-used.

The amount of the heavy metal compound to be used, a temperature condition, and treating period at the contact of the ultraviolet-irradiated portion with the heavy metal compound may be suitably selected from those described in the above.

For forming a predetermined pattern on the poly(methyl methacrylate) basal plate using the patterning material of the present invention, for example, a masking portion having a predetermined shape may be formed on the poly(methyl methacrylate) basal plate having an ultraviolet-irradiated portion and then it may be brought into contact with vapor of the heavy metal compound to form metal nanoparticles at the non-masking portion.

The poly(methyl methacrylate)-metal cluster composite of the present invention is expected to have a wide variety of applications as a patterning material for expressing functions and properties for nanolithography, photonic crystals, high-density recording media, catalysts, or the like.

For example, when a micropattern is formed on a silicon substrate in the conventional ultraviolet lithography technology, a photo-polymerizable monomer is usually used as a resist material and a step of washing away an unexposed portion after curing is required. However, in the case of the metal cluster complex of the present invention, patterning is achieved by the heavy metal nanoparticles having an excellent etching resistance in the poly(methyl methacrylate) film and hence the etching resistance is improved as compared with conventional polymer resists. Therefore, a step of washing away an uncured portion, which is a conventional step, is not required and it is possible to remove a region containing no metal fine particles by plasma treatment. Thus, since a concavo-convex pattern can be easily obtained on a silicon substrate by a dry process, the poly(methyl methacrylate)-metal cluster composite can be a very high resolution photoresist excellent in durability.

Moreover, a material in which two or more kinds of substances different in refractive index are arranged at a cycle equal to the wavelength of a light in a two-dimensional cycle becomes photonic crystals forming a photonic band which does not propagate a light having a specific wavelength, and the crystals can be used as elements for optical fibers, prisms, light guides and the like. With regard to the metal cluster complex of the present invention, since a phase composed of the polymer alone and a polymer phase containing a metal can be arranged alternatively and regularly, it is possible to obtain photonic crystals having an extremely large difference in refractive index.

Furthermore, since fine particles of a heavy metal such as cobalt or nickel for use in the present invention have magnetism, a high-density magnetic recording material can be obtained by arranging these particles regularly at a micro-level on a poly(methyl methacrylate) film at even intervals.

The fine particles of a heavy metal such as palladium for use in the present invention can be used as a catalyst, which has a high catalytic activity since these nanoparticles have an extremely large surface area. Moreover, when a basal plate on which these fine particles are regularly arranged is applied to CVD (chemical vapor deposition), it becomes possible to grow a material such as carbon nanotube on the basal plate two-dimensionally and regularly.

### EXAMPLES

The present invention is described below in more detail with reference to Examples.

### Example 1

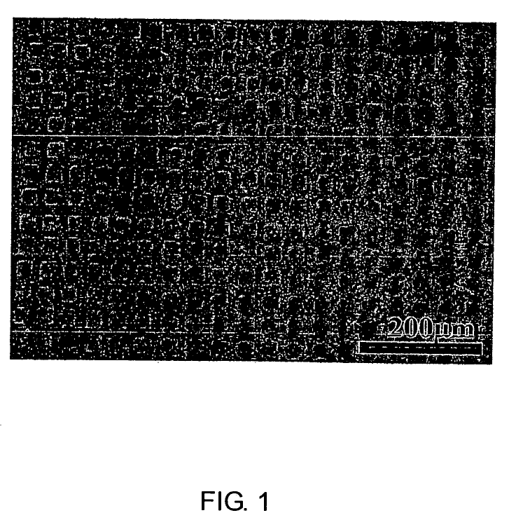

A poly(methyl methacrylate) (PMMA) film on which a metal mesh having a large number of holes of 5-μm-square had been placed as a mask was irradiated with ultraviolet ray (containing wavelength of 250 nm to 350 nm) of 1.9 J/cm² by means of a mercury lamp. After removal of the mask, the film and palladium(II) acetylacetonate were placed in a glass tube and, under a nitrogen atmosphere, the glass tube was immersed in an oil bath at 180° C. for 15 minutes. The palladium(II) acetylacetonate sublimed and diffused inside the PMMA film. Since the portion exposed to ultraviolet ray strongly reduced the metal complex, a pattern of metal nanoparticles was obtained in accordance with the pattern of the metal mesh used as the mask. When the film was observed by a back scattering mode on a scanning electron microscope (SEM), the portion where the metal was formed strongly scattered an electron beam and hence afforded a bright contrast, so that it was confirmed that the pattern of the photo-mask was accurately transferred (FIG. 1).

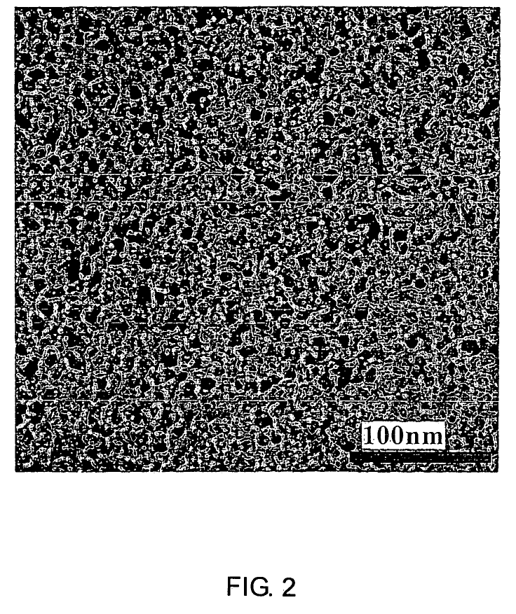

Moreover, when a cross-section having a thickness of about 100 nm was cut out of the film and was observed by a transmission electron microscope (TEM), a large number of palladium particles having a diameter of about 5 nm were dispersed in the portion exposed to the light (FIG. 2). On the other hand, no metal fine particle was observed at the portion which was not exposed to the light.

### Example 2

When vapor of cobalt(II) acetylacetonate and the PMMA film were placed under a nitrogen atmosphere at 180° C. for 30 minutes in the same manner as in Example 1, except that palladium(II) acetylacetonate was replaced with the cobalt complex, a micropattern of cobalt fine particles was obtained as in the case of palladium. It was confirmed by TEM observation that a large number of cobalt fine particles having a diameter of about 10 nm were dispersed in PMMA irradiated with the light.

### Example 3

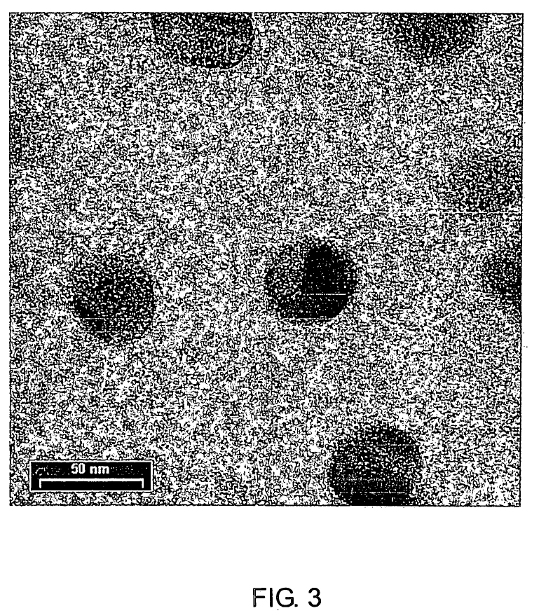

When vapor of copper(II) acetylacetonate and the PMMA film were placed under a nitrogen atmosphere at 180° C. for 30 minutes in the same manner as in Example 1, except that palladium(II) acetylacetonate was replaced with the copper complex, a micropattern of copper fine particles was obtained as in the case of palladium. It was confirmed by TEM observation that a large number of cobalt fine particles having a diameter of about 50 nm were dispersed in PMMA irradiated with the light (FIG. 3).

### Comparative Example 1

An experiment was carried out in the same manner as in Example 1, except that ultraviolet irradiation was not conducted. In this case, the reducing power of the poly(methyl methacrylate) was weak, so that metal fine particles were not formed and a desired metal cluster complex was not obtained.

### Comparative Example 2

An experiment was carried out in the same manner as in Example 1, except that irradiation was conducted with a visible light while a filter cutting wavelength of 350 nm or shorter was fitted to the mercury lamp of Example 1.

In this case, the reducing power of the poly(methyl methacrylate) was not changed, so that palladium fine particles were hardly formed and a poly(methyl methacrylate)-metal cluster composite was not obtained. Also, micropatterning was impossible.

### INDUSTRIAL APPLICABILITY

According to the present invention, a poly(methyl methacrylate)-metal cluster composite, which is hitherto difficult to produce, can be conveniently and efficiently produced as molded articles having a specific shape, e.g., basal forms such as a film shape or a sheet shape, or the like.

Moreover, the poly(methyl methacrylate)-metal cluster composite of the present invention is expected to have a wide variety of applications as a patterning material for expressing functions and properties for nanolithography, photonic crystals, high-density recording media, catalysts or the like.

1. A process for producing a poly(methyl methacrylate)-metal cluster composite, which comprises bringing poly(methyl methacrylate) into contact with a heavy metal compound under ultraviolet irradiation.

2. A process for producing a poly(methyl methacrylate)-metal cluster composite, which comprises bringing a poly(methyl methacrylate) basal plate having an ultraviolet-irradiated portion into contact with vapor of a heavy metal compound to form heavy metal nanoparticles on the ultraviolet-irradiated portion.

3. The process for producing a poly(methyl methacrylate)-metal cluster composite according to claim 1 or 2, wherein the heavy metal compound is selected from acetylacetonate complexes of palladium, cobalt or copper.

4. The process for producing a poly(methyl methacrylate)-metal cluster composite according to claim 2, wherein the poly(methyl methacrylate) basal plate is brought into contact with vapor of the heavy metal compound in a non-oxidizing atmosphere.

5. The process for producing a poly(methyl methacrylate)-metal cluster composite according to claim 2, wherein the poly(methyl methacrylate) basal plate is brought into contact with vapor of the heavy metal compound at a temperature of glass transition temperature of the poly(methyl methacrylate) basal plate or higher.

6. The process for producing a poly(methyl methacrylate)-metal cluster composite according to claim 2, wherein the ultraviolet-irradiated portion is formed in a predetermined pattern.

7. The process for producing a poly(methyl methacrylate)-metal cluster composite according to claim 6, wherein the predetermined pattern is formed by masking.

8. A patterning material which comprises a poly(methyl methacrylate)-metal cluster composite obtainable by the process according to claim 1 or 2.

9. A method for patterning metal nanoparticles having a predetermined form on a poly(methyl methacrylate) basal plate, which comprises forming a masking portion having a predetermined form on the poly(methyl methacrylate) basal plate having an ultraviolet-irradiated portion, and then bringing the plate into contact with vapor of a heavy metal compound to form metal nanoparticles on a non-masking portion.
